(19) United States
(12) Patent Application Publication
(10) Pub. No.: US 2015/0302321 A1
(43) Pub. Date: Oct. 22, 2015

(54) UNIT-BASED LICENSING FOR EVENT AND DIGITAL CONTENT ACCESS

(71) Applicant: Altair Engineering, Inc., Troy, MI (US)

(72) Inventors: James R. Scapa, West Bloomfield, MI (US); Stephanie Scapa, Menlo Park, CA (US); Massimo Fariello, Turin (IT)

(21) Appl. No.: 14/448,005

(22) Filed: Jul. 31, 2014

Related U.S. Application Data
(60) Provisional application No. 61/982,678, filed on Apr. 22, 2014.

(51) Int. Cl. G06Q 10/02

(52) U.S. Cl. CPC G06Q 10/02

(57) ABSTRACT

A method and apparatus for unit-based licensing for event and digital content access are provided. Unit-based licensing for event and digital content access may include receiving a request for access to an event, the request for access indicating a customer account, determining a cardinality of assigned units for the event, identifying a cardinality of available licensing units allocated to the customer account, determining whether the cardinality of the assigned units is within the cardinality of the available licensing units, and outputting a response. Outputting the response may include indicating that the request is granted, on a condition that the cardinality of the assigned units is within the cardinality of the available licensing units, and indicating that the request is denied, on a condition that the cardinality of the assigned units exceeds the cardinality of the available licensing units.

### CROSS-REFERENCE TO RELATED APPLICATIONS

This application claims priority to U.S. Provisional Patent Application No. 61/982,678, filed on Apr. 22, 2014, which is incorporated by reference in its entirety herein.

### TECHNICAL FIELD

The present disclosure relates to systems and methods of licensing access to events and digital content.

### BACKGROUND OF THE DISCLOSURE

Digital content such as computer software products, video games, music, and any other media capable of being embodied in digital format may be sold or licensed to an end user customer. For example, the right to copy, access, or execute the digital content may be licensed to a user and a provider or vendor may retain ownership of the rights to the content. Content, such as digital content, or live-performance content may be presented at an event, such as a concert, a gallery display, a sporting event, or any multiple access presentation of content. Accordingly, it may be desirable to provide unit-based licensing for event and digital content access.

### SUMMARY OF THE DISCLOSURE

Disclosed herein are aspects, features, elements, implementations, and embodiments of unit-based licensing for event and digital content access.

In an embodiment, a method of unit-based licensing for event and digital content access is disclosed. Unit-based licensing for event and digital content access may include receiving a request for access to an event, the request for access indicating a customer account, determining a cardinality of assigned units for the event, identifying a cardinality of available licensing units allocated to the customer account, determining, by a processor in response to instructions stored on a non-transitory computer readable medium, whether the cardinality of the assigned units is within the cardinality of the available licensing units, and outputting a response. Outputting the response may include indicating that the request is granted, on a condition that the cardinality of the assigned units is within the cardinality of the available licensing units, and indicating that the request is denied, on a condition that the cardinality of the assigned units exceeds the cardinality of the available licensing units.

In another embodiment, an apparatus for unit-based licensing for event and digital content access is disclosed. The apparatus may include a non-transitory computer readable memory and a processor configured to execute instructions stored on the memory to receive a request for access to an event, the request for access indicating a customer account, determine a cardinality of assigned units for the event, identify a cardinality of available licensing units allocated to the customer account, determine whether the cardinality of the assigned units is within the cardinality of the available licensing units, and output a response. Outputting the response may include indicating that the request is granted, on a condition that the cardinality of the assigned units is within the cardinality of the available licensing units, and indicating that the request is denied, on a condition that the cardinality of the assigned units exceeds the cardinality of the available licensing units.

In another embodiment, a method of accessing event and digital content using unit-based licensing is disclosed. Accessing event and digital content using unit-based licensing may include transmitting a request for access to an event, the request for access indicating a customer account, receiving a response indicating that the request is granted on a condition that a cardinality of assigned units for the event is within a cardinality of available licensing units allocated to the customer account, and receiving a response indicating that the request is denied on a condition that the cardinality of the assigned units for the event exceeds the cardinality of the available licensing units.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The description herein makes reference to the accompanying drawings wherein like reference numerals refer to like parts throughout the several views, and wherein:

FIG. 1 is a diagram of an example of a communication system for unit-based licensing for event and digital content access in accordance with embodiments of this disclosure; and

FIG. 2 is a flow diagram of an example of unit-based licensing for event and digital content access in accordance with embodiments of this disclosure; and

FIG. 3 is a flow diagram of an example of accessing event and digital content using unit-based licensing in accordance with embodiments of this disclosure.

### DETAILED DESCRIPTION

A creator or owner of content, such as digital content or live-performance content, may control access to the content by licensing the content to end users. For example, licensing may include controlling the right to display, perform, distribute, or reproduce the content. Unit-based licensing may include licensing that controls access to content by allocating licensing units to a customer account, such that one or more licensing units may be redeemed or charged to access one or more events or digital content objects.

In some embodiments, licensing units may be redeemed for access to events, digital content, or a combination thereof. In some embodiments, each digital content object or event that may be accessed by a user may be assigned a number of units that will be charged upon access of the digital content object or event. In some examples, unit-based licensing for events and digital content may include licensing for a single customer or for a customer group, wherein multiple group members may share licensing units.

The aspects, features, elements, and embodiments of methods, procedures, or algorithms disclosed herein, or any part or parts thereof, may be implemented in a computer program, software, or firmware incorporated in a non-transitory computer-readable storage medium for execution by a general purpose or special purpose computer or processor, and may be implemented as a computer program product, such as a computer program product accessible from a tangible computer-usable or computer-readable medium.

As used herein, the terminology “computer” or “device” includes any unit, or combination of units, capable of performing any method, or any portion or portions thereof, disclosed herein. Devices may further include mobile devices that may include user equipment, a wireless transmit/receive unit, a mobile station, a fixed or mobile subscriber unit, a pager, a cellular telephone, a personal digital assistant (PDA), a computer, or any other type of user device capable of operating in a mobile environment.

As used herein, the terminology “processor” includes a single processor or multiple processors, such as one or more general purpose processors, one or more special purpose processors, one or more conventional processors, one or more digital signal processors, one or more microprocessors, one or more controllers, one or more microcontrollers, one or more Application Specific Integrated Circuits (ASICs), one or more Application Specific Standard Products (ASSPs); one or more Field Programmable Gate Arrays (FPGAs) circuits, any other type or combination of integrated circuits (ICs), one or more state machines, or any combination thereof.

As used herein, the terminology “memory” includes any computer-usable or computer-readable medium or device that can, for example, tangibly contain, store, communicate, or transport any signal or information for use by or in connection with any processor. Examples of computer-readable storage mediums may include one or more read only memories, one or more random access memories, one or more registers, one or more cache memories, one or more semiconductor memory devices, one or more magnetic media, such as internal hard disks and removable disks, one or more magneto-optical media, one or more optical media such as CD-ROM disks, and digital versatile disks (DVDs), or any combination thereof.

As used herein, the terminology “example”, “embodiment”, “implementation”, “aspect”, “feature”, or “element” indicate serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein. As used herein, the terminology “cardinality” includes a number or count of elements or items in a set, group, plurality, or any other collection of zero or more elements.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terminology “digital content” may include computer software programs, video games, music, movies, videos, or any other media that may be embodied in digital form, and which may be accessed, downloaded, input, or otherwise transferred to a computer or processor. Digital content may include digital data or digital files that may be processed by external application programs or may be executed by external software, hardware, or both. As used herein, the terminology “content” may include live content or fixed content. Fixed content may include any content that may be presented from a tangible storage medium, such as digital content. Live content, or live-performance content, may include any content that may be accessed substantially concurrently with the creation or generation of the content, such as the presentation of a movie in a movie theater, a concert, a sporting event, a gallery display, or any other live event.

As used herein, the terminology “event” may include any presentation, distribution, or display of content capable of concurrent, or nearly concurrent, access by multiple users. For example, an event may include a physical presentation, such a presentation at a movie theater, concert hall, museum, or restaurant, or a virtual presentation, such as a broadcast over the Internet or a television broadcast. In addition, an event may include a natural or artificial attraction, such as national park, a state park, or an amusement park.

As used herein, the terminology “access” or “accessing” may include presenting, downloading, executing, streaming, or otherwise interacting, or enabling interaction, with a content object, and may include physically, virtually, or constructively accessing an event or content object. For example, physically accessing an event may include physically entering a venue associated with the event at a time associated with the vent by a user, or may include communicating information indicating the physical entry into the venue by the user. In another example, virtual access to an event may include accessing a virtual event venue, such as opening a web site or tuning to a television channel, or communicating information indicating access to the virtual event venue. In some embodiments, constructive access to an event may be based on performance of the event. For example, a user may register for an event, and the user may constructively access the event during the event performance, or during a period of time associated with accessing the event. In some embodiments, digital content objects may be executed, stored, or both, at a provider location. In some embodiments, digital content objects may be stored locally on a customer network or customer device and the digital content objects may be executed or run on the customer network or device.

In some embodiments, a node based license may indicate that content is accessible by a unique device, such as a computer, a unique account, such as an account associated with an individual user, or a combination of a unique device and a unique account. In some embodiments, a network based license may indicate that content is accessible by one or more devices within a specified network. For example, a defined number of devices within the network may concurrently access the content. In some embodiments, a license, including a node based license or a network based license, may be associated with a unique content object, or with a suite of related content objects.

As used herein, the terminology “assigned units”, “price”, “licensing price” or variations thereof, may include an assigned number of licensing units that may be exchanged or redeemed to access particular content, such as an event or a digital content object. As used herein, the terminology “licensed units” or “allocated units” may refer to a total number of units provided to a customer or customer group. As used herein, the terminology “checked out units”, “redeemed units”, or “exchanged units” may refer to assigned units charged to a customer for content being accessed. “Available units” may refer to a difference between licensed units and checked out units. In some embodiments, licensing units may be temporarily or permanently exchanged for access. Temporarily exchanged licensing units may be returned to the pool of available units associated with the customer upon termination or completion of content access.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

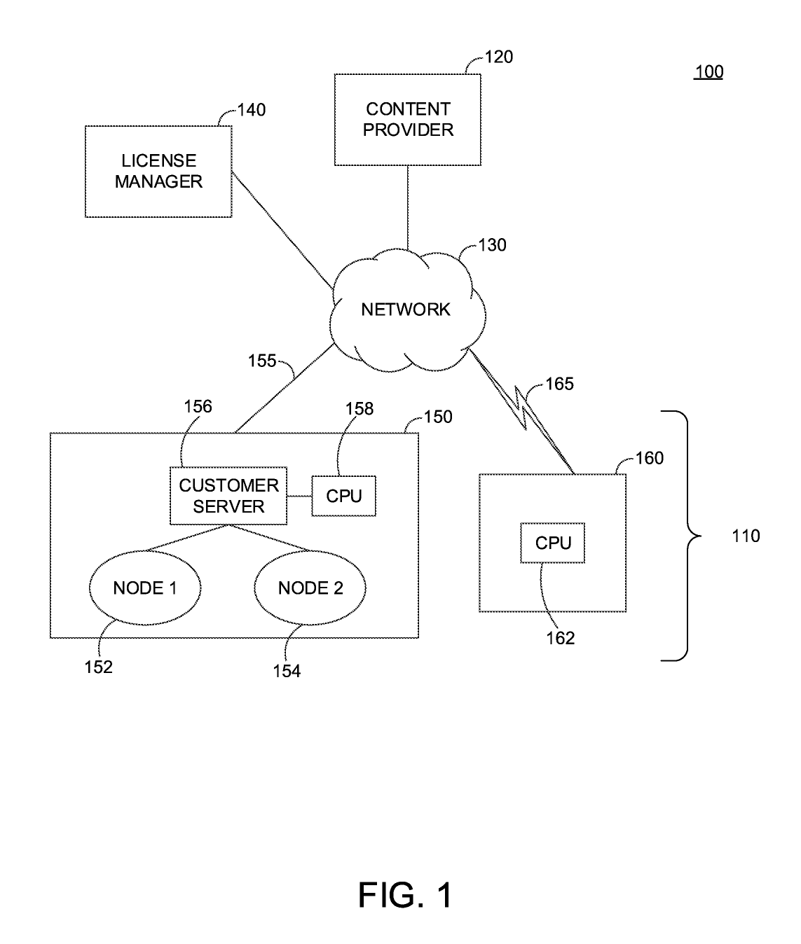

FIG. 1 is a diagram of an example of a communication system 100 for unit-based licensing for event and digital content access in accordance with embodiments of this disclosure. For simplicity, the communication system 100 shown in FIG. 1 includes a customer system 110, a provider 120, a network 130, and a license manager 140; however, other elements, such as multiple networks, access points, or communication mediums may be included in a communication system for unit-based licensing for event and digital content access.

In some embodiments, customer system 110 may be associated with an individual user or customer, and the user may access content using licensing units allocated to the user. In some embodiments, customer system 110 may comprise devices and networks through which a customer or user may access digital content from provider 120, or register for, or access, events. For example, as shown in FIG. 1, customer system 110 may include a customer network 150 and a customer device 160; however, any number of customer networks and customer devices may be used.

In some implementations, customer system 110 may be associated with a collection or group of customers, or members, and shared licensing units may be allocated to the group. For example, a group may include one or more families, a classroom of students, a small business, a social group, or any other organization capable of licensing content such that members of the group are capable of accessing the content.

In some embodiments, elements of the customer system 110, such as customer network 150 and customer device 160, may communicate with each other or with elements external to the customer system 110, such as the provider 120. For example, customer network 150 and customer device 160 may independently communicate through communication network 130.

In some embodiments, customer network 150 may include one or more individual nodes 152/154, a customer server 156, a host processor (CPU) 158, or any combination thereof. A node 152/154 may be a device, such as a computer, and may access digital content, or register for or access an event. For example, a node 152/154 may access digital content, or register for or access an event, in response to user input. Although FIG. 1 includes a first node 152 and a second node 154 for simplicity, any number of nodes may be used. In some embodiments, a node 152/154 may be connected to a customer server 156 and may have a unique network address. In some embodiments, a node 152/154 may communicate with other nodes 152/154 within customer network 150. The customer server 156 may communicate with CPU 158. Although individual nodes 152/154 are depicted as being connected in a spoke configuration to the customer server 156, the individual nodes 152/154 may be connected in any other electronic computer network configuration. Although shown as separate units, in some embodiments, customer server 156 and CPU 158 may be combined into a single device.

In some embodiments, customer device 160 may be any device, such as a computer or mobile device, capable of accessing digital content, or registering for or accessing an event. In some embodiments, a customer device 160 may include a processor, such as CPU 162.

In some embodiments, provider 120 may be a device or system configured to provide access to digital content, or registration for or access an event, to one or more licensed customers. For example, provider 120 may include an Internet Protocol (IP) network-based unit, such as a website service, that implements methods for controlling access to events or digital content. In some embodiments, provider 120 may provide customer system 110 access to content, which may be included in a suite of content, which may include digital content objects, events, or both. In some embodiments, provider 120 may be any system configured to control access to or registration for events by licensed users. Although FIG. 1 shows the provider 120 as a single unit, the provider 120 may include any number of discrete units and any number of providers 120 may be used.

In some embodiments, the provider 120 may include an event provider (not shown separately) and may control access to or registration for one or more events. The event provider may be any system configured to receive a request to access or register for an event and output a response indicating whether access or registration is granted. In some embodiments, the request for access may include a request to register for the event, which may include receiving registration information. In some embodiments, the event provider may be the provider 120. In some embodiments, the event provider may be separate from the provider 120. Although shown as a single unit in FIG. 1, in some embodiments, the provider 120 may include a content provider as a first unit and the event provider as a second unit. For example, the content provider and the event provider may be independent units within a single physical device, or may be independent physical devices.

In some implementations, unit-based licensing for events and digital content may include communication between the customer system 110 and the provider 120 via the communication network 130. The communication network 130 may be a local area network (LAN), wide area network (WAN), virtual private network (VPN), a mobile or cellular telephone network, the Internet, or any other electronic communication medium. Although not explicitly shown in FIG. 1, each of the customer system 110, provider 120, and license manager 140 may communicate with communication network 130 through one or more Internet service providers (ISPs). In some embodiments, the customer network 150, the customer device 160, or both, may communicate with the network 130 via a wired connection 155 a wireless connection 165, or a combination of one or more wired or wireless connections.

In some embodiments, a license manager (LM) 140 may be included in the communication system 100. License manager 140 may control the access to events, digital content, or both, provided by provider 120. Although shown as a separate unit, in some embodiments, license manager 140 may be incorporated with provider 120, customer system 110, or both. In some embodiments, the license manager 140 may monitor content access for the customer system 110. For example, the license manager 140 may detect the termination or conclusion of access to content.

In some embodiments, license manager 140 may generate and maintain a log. The log may include a record of a number of available units that may be used by the customer system 110 at any given time. In some embodiments, the license manager 140 may update the log for each change of the available units for customer system 110. For example, the log may be updated to indicate a change in the available units in response to the registration for or accessing of events or digital content from provider 120, the termination of the access to events or access of digital content, or cancelation of a registration for an event, or a change in pricing of events or digital content being accessed by the customer. In some embodiments, the log may be a file, or database, stored in a memory in communication with provider 120 or license manager 140.

Although not shown in FIG. 1, in some embodiments, communication system 100 may include a registration unit. In some embodiments, a registration unit may be a device, such as a computer. For example, the registration unit may be a kiosk physically located at an event location. In some embodiments, the registration unit may be configured to receive registration information. For example, the registration unit may include a user interface device, such as a keyboard or touchscreen, and may receive user input indicating registration information via the user input device.

In some embodiments, the registration unit may communicate with a user device, such as customer device 160. For example, the customer device may send registration information to the registration unit. In some embodiments, a user device may communicate with the registration unit wirelessly. For example, the registration unit may receive registration information from a user device via wireless radio communication, such as Bluetooth or near field communication (NFC) or via optical communication, such as a scan code, a quick response (QR) code, or an infrared signal. The registration unit may communicate with the provider, such as through a communication network.

In some embodiments, registration information may include customer identification information. In some embodiments, the registration information may include a number of assigned units, available units, or checked out units associated with the customer. In some embodiments, registration information may include event identification information, which may include an event name, time, or place.

In some embodiments, registration information may be sent to allow a user to reserve or hold their place at a particular event. Assigned units may or may not be charged to the user at the time of registration. For example, assigned units may not be charged to a user at the time of registration, but may be charged upon accessing the event.

In some embodiments, unit-based licensing for events and digital content may include controlling access to events and digital content in response to a request to access the event or digital content. For example, customers may apply licensed units toward the access of events, digital content, or a combination thereof.

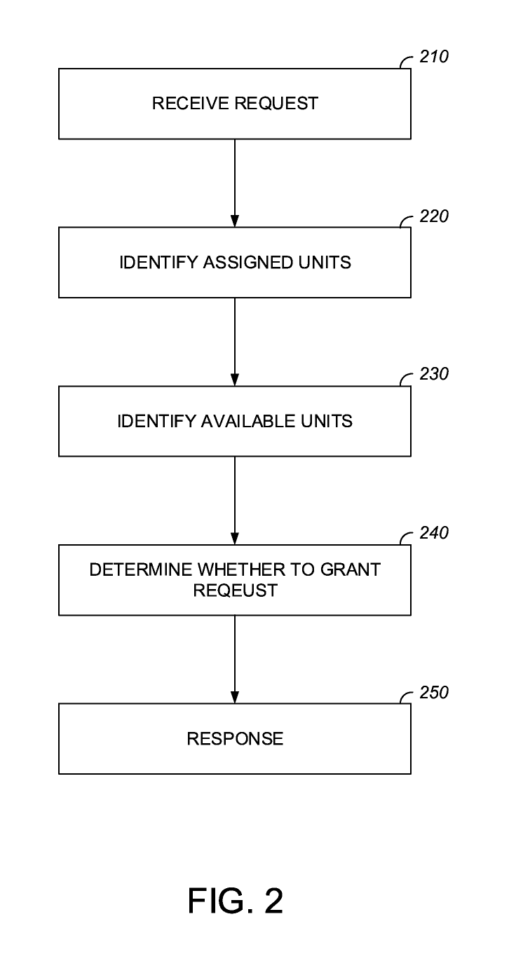

FIG. 2 is a flow diagram of an example of unit-based licensing for event and digital content access in accordance with embodiments of this disclosure. Unit-based licensing for event and digital content access may include temporarily or permanently exchanging licensing units for access to content, such as digital content or event content. In some embodiments, unit-based licensing for event and digital content access may be implemented in a communication system, such as the communication system 100 shown in FIG. 1.

In some embodiments, unit-based licensing for event and digital content access may include receiving a request to access an event or a digital content object at 210, identifying an amount of assigned units for the event or digital content object at 220, identifying an amount of available units 230, determining whether to grant the request at 240, responding to the request at 250, or a combination thereof.

In some embodiments, a request to access content may be received at 210. For example, a provider, such as the provider 120 shown in FIG. 1, may receive the request from a customer, such as the customer system 110 shown in FIG. 1, via a network, such as the network 130 shown in FIG. 1. In some embodiments, the request may indicate a selected digital content object or an event. In some embodiments, the request to access content may include information identifying the customer, such as account information associated with the customer system.

In some embodiments, assigned license units for the selected event or digital content may be identified at 220. In some embodiments, the number of assigned units for a digital content object or event may remain constant or may vary over time. In some embodiments, a license manager, such as the license manager 140 shown in FIG. 1, may identify the assigned license units for the selected digital content or event. In some embodiments, the license manager may be independent of the provider, and the license manager may receive the request via the customer system or via the provider.

In some embodiments, a number or cardinality of available units associated with the customer system may be determined at 230. The available units may indicate a number of licensing units that may be used by the customer system at a given time, such as at the time the request is received. For example, although not shown in FIG. 2, one or more licensing units may be allocated or licensed to the customer system, one or more of the allocated units may be temporarily or permanently exchanged or checked out for access to content, and the number of available units may indicate the difference between the number of allocated units and the number of checked out units.

In some embodiments, subgroups may be identified within the customer system and a portion of the available units associated with the customer system may be allocated to each respective subgroup. For example, the nodes 152/154 shown in FIG. 1 may be included in a first subgroup, and the customer device 160 shown in FIG. 1 may be include in a second subgroup.

In some embodiments, whether to grant access may be determined at 240. For example, determining whether to grant access at 240 may include determining whether the count of available units for the customer or the customer subgroup is equal to or greater than the number of assigned units for the digital content or event. In some embodiments, determining whether to grant access may include evaluating other factors, such as the existence of a previous registration for the event by the user or customer, or availability of the event, which may be based on attendance and capacity information for the venue.

In some embodiments, a response may be output at 250. For example, the provider or licensing manager may generate a response indicating that the request for access is granted or denied and may transmit the response to the requesting device, the customer system, or both.

In some embodiments, the request for access or registration may be denied. For example, the number of available units associated with the customer or the customer subgroup may be less than the number of assigned units for the requested digital content or event and the request may be denied. In some embodiments, the provider may reject the request and may prevent the customer system, the requesting device, or both, from accessing to the content. In some embodiments, the event provider may output a signal or message indicating the request to access or register for an event is denied.

In some embodiments, the request for access may be granted. For example, the number of available units associated with the customer or the customer subgroup may be equal to or greater than the number of assigned units for the requested digital content or event and the request may be granted.

Although not shown separately, in some embodiments, granting the request may include charging, redeeming, or exchanging a number of available licensing units allocated to the customer system or the customer subgroup corresponding to the number of assigned units for the digital content object or event. For example, the license manager or provider may record the number of licensing units charged, may update the number available units associated with the customer system or the customer subgroup, or both. In some embodiments, the license manager or provider may record any change in charged units or available units in a log. In some embodiments, the number of available units for the customer system or the customer subgroup may be decreased in an amount equal to the number of assigned units for the digital content or event indicated in the request. In some embodiments, the number of licensing units charged to the customer for accessing content may be based on the difference between the assigned units for the content and a number of units previously charged for registering for access to the content.

In some embodiments, granting the request may include determining whether to charge one or more of the available licensing units allocated to the customer system or the customer subgroup. For example, the provider or the licensing manager may determine the number of checked out units currently charged against the customer system or the customer subgroup, and may determine a number of licensing units to charge against the customer system or the customer subgroup based on a difference between the number of assigned units for the requested content and the number of currently checked out units for the customer or the customer subgroup. For example, the number of currently checked out units for the customer or the customer subgroup may be greater than the number of assigned units and granting the request may omit checking out available units. In another example, the number of currently checked out units for the customer or the customer subgroup may be less than the number of assigned units and granting the request may include checking out a number of available units equal to the difference between the number of assigned units and the number of currently checked out units.

Although not shown separately, in some embodiments, a device, or a user associated with the device, may access the content, in response to receiving a response granting the request. For example, the device may receive the requested content from the provider via the customer system. In some embodiments, the available units for the customer or the customer subgroup may be updated in response to the device accessing the content. In some examples, the event provider may indicate that the request for access to an event is granted.

Although not shown separately, in some embodiments, the number of charged units may be returned to the customer system or the customer subgroup upon completion or termination of the access of the content.

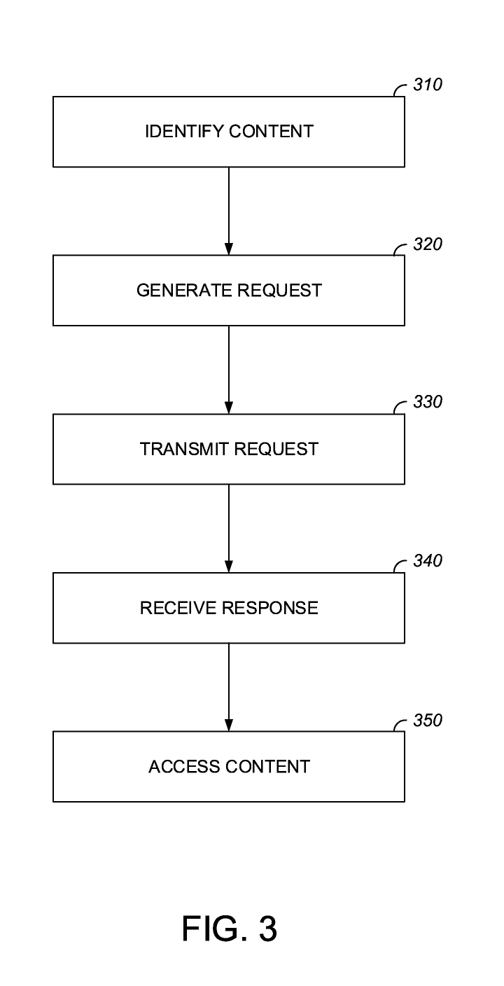

FIG. 3 is a flow diagram of an example of accessing event and digital content using unit-based licensing in accordance with embodiments of this disclosure. Accessing event and digital content using unit-based licensing may include temporarily or permanently exchanging licensing units for access to content, such as digital content, event content, or a combination thereof. In some embodiments, accessing event or digital content using unit-based licensing may be implemented in a communication system, such as the communication system 100 shown in FIG. 1.

In some embodiments, accessing event and digital content using unit-based licensing may include identifying a digital content object or an event at 310, generating a request to access the digital content object or the event at 320, transmitting the request to access the digital content object or the event at 330, receiving a response to the request at 340, accessing the digital content object or the event at 350, or a combination thereof.

In some embodiments, a digital content object or an event may be identified at 310. For example, identifying the digital content object may include identifying a computer software program, video game, music, a movie, a video, or any other media that may be embodied in digital form, and may be accessed, downloaded, input, or otherwise transferred to a computer or processor. In some embodiments, identifying a digital content object or event may include identifying a plurality of digital content objects, a plurality of events, or a combination of digital content objects and events.

In some embodiments, a request to access the identified digital content object or event may be generated at 320. In some embodiments, the request may indicate the digital content object or event identified at 310. In some embodiments, the request to access content may include information identifying the customer, such as account information associated with the customer system, and may include information identifying the device accessing the content or a user accessing the content, such as an identifier of the device 160 shown in FIG. 1. For example, the customer system may include a network, such as a wireless network, and the accessing device may connect to the network and may send a request to access content to the provider via the network of the customer system.

In some embodiments, a request to access the identified digital content object or event may be transmitted at 330. For example, a requesting device, such as the device 160 shown in FIG. 1, may transmit the request to a provider, such as the provider 120 shown in FIG. 1, via a customer, such as the customer system 110 shown in FIG. 1. Although the device 160 is shown in FIG. 1 as communicating via the customer system, the device may communicate via a third party network, such as the network 130 shown in FIG. 1.

In some embodiments, a response to the request may be received at 340. For example, the provider or licensing manager may generate a response indicating that the request for access is granted or denied and may transmit the response to the requesting device, the customer system, or both.

In some embodiments, the response may indicate whether the request is granted or denied. In some embodiments, whether the request is granted or denied may depend on a count or cardinality of assigned license units for the selected digital content or event. In some embodiments, the number of assigned units for a digital content object or event may remain constant or may vary over time. In some embodiments, a license manager, such as the license manager 140 shown in FIG. 1, may identify the assigned license units for the selected digital content or event. In some embodiments, the license manager may be independent of the provider, and the license manager may receive the request via the customer system or via the provider.

In some embodiments, whether the request is granted or denied may depend on a count or cardinality of available licensing units associated with the customer system. The available units may indicate a number of licensing units that may be used by the customer system at a given time, such as at the time the request is received. For example, although not shown in FIG. 2, one or more licensing units may be allocated or licensed to the customer system, one or more of the allocated units may be temporarily or permanently exchanged or checked out for access to content, and the number of available units may indicate the difference between the number of allocated units and the number of checked out units.

In some embodiments, subgroups may be identified within the customer system and a portion of the available units associated with the customer system may be allocated to each respective subgroup. For example, the nodes 152/154 shown in FIG. 1 may be included in a first subgroup, and the customer device 160 shown in FIG. 1 may be include in a second subgroup.

In some embodiments, whether the request is granted or denied may be based on whether the count of available units for the customer or the customer subgroup is equal to or greater than the number of assigned units for the content.

In some embodiments, the request for access may be denied. For example, the number of available units associated with the customer or the customer subgroup may be less than the number of assigned units for the requested content and the request may be denied. In some embodiments, the provider may reject the request and may prevent the customer system, the requesting device, or both, from accessing to the content.

In some embodiments, the request for access may be granted. For example, the number of available units associated with the customer or the customer subgroup may be equal to or greater than the number of assigned units for the requested content and the request may be granted.

Although not shown separately, in some embodiments, granting the request may include charging, redeeming, or exchanging a number of available licensing units allocated to the customer system or the customer subgroup corresponding to the number of assigned units for the content. For example, the license manager or provider may record the number of licensing units charged, may update the number available units associated with the customer system or the customer subgroup, or both. In some embodiments, the license manager or provider may record any change in charged units or available units in a log. In some embodiments, the number of available units for the customer system or the customer subgroup may be decreased in an amount equal to the number of assigned units for the content indicated in the request.

In some embodiments, granting the request may include determining whether to charge one or more of the available licensing units allocated to the customer system or the customer subgroup. For example, the provider or the licensing manager may determine the number of checked out units currently charged against the customer system or the customer subgroup, and may determine a number of licensing units to charge against the customer system or the customer subgroup based on a difference between the number of assigned units for the requested content and the number of currently checked out units for the customer or the customer subgroup. For example, the number of currently checked out units for the customer or the customer subgroup may be greater than the number of assigned units and granting the request may omit checking out available units. In another example, the number of currently checked out units for the customer or the customer subgroup may be less than the number of assigned units and granting the request may include checking out a number of available units equal to the difference between the number of assigned units and the number of currently checked out units.

In some embodiments, the requesting device may access the digital content in response to receiving a response granting the request at 350. For example, the requesting device may receive the requested content from the provider via the customer system. In some embodiments, the available units for the customer or the customer subgroup may be updated in response to the device accessing the content.

Although not shown separately, in some embodiments, the number of charged units may be returned to the customer system or the customer subgroup upon completion or termination of the access of the digital content.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method comprising:
receiving a request for access to an event, the request for access indicating a customer account;
determining a cardinality of assigned units for the event;
identifying a cardinality of available licensing units allocated to the customer account;
determining, by a processor in response to instructions stored on a non-transitory computer readable medium, whether the cardinality of the assigned units is within the cardinality of the available licensing units; and
outputting a response, wherein outputting the response includes:
indicating that the request is granted, on a condition that the cardinality of the assigned units is within the cardinality of the available licensing units, and
indicating that the request is denied, on a condition that the cardinality of the assigned units exceeds the cardinality of the available licensing units.

2. The method of claim 1, wherein the event includes a presentation of content such that the presentation is accessible by a plurality of users.

3. The method of claim 1, wherein the request for access to the event indicates a request to access a venue at a time and location associated with a presentation of content.

4. The method of claim 3, wherein the location is a geographical location.

5. The method of claim 3, wherein the location is a location in a telecommunications system.

6. The method of claim 1, wherein the request for access indicates a user associated with the customer account, the method further comprising identifying access to the event by the user.

7. The method of claim 6, further comprising reducing the cardinality of the available licensing units by the cardinality of the assigned units in response to identifying access to the event by the user.

8. The method of claim 7, wherein access to the event by the user is identified in response to initiation of the event.

9. The method of claim 1, wherein the request for access includes a request to register for the event.

10. The method of claim 8, further comprising on a condition that the cardinality of the assigned units exceeds the cardinality of the available licensing units, storing information indicating a registration for access to the event for the customer account.

11. The method of claim 9, wherein storing information indicating the registration for access to the event for the customer account includes reducing the cardinality of the available licensing units by the cardinality of the assigned units.

12. An apparatus comprising:
a non-transitory computer readable memory; and
a processor configured to execute instructions stored on the memory to:
receive a request for access to an event, the request for access indicating a customer account;
determine a cardinality of assigned units for the event;
identify a cardinality of available licensing units allocated to the customer account;
determine whether the cardinality of the assigned units is within the cardinality of the available licensing units; and
output a response, wherein outputting the response includes:
indicating that the request is granted, on a condition that the cardinality of the assigned units is within the cardinality of the available licensing units, and
indicating that the request is denied, on a condition that the cardinality of the assigned units exceeds the cardinality of the available licensing units.

13. The apparatus of claim 11, wherein the event includes a presentation of content such that the presentation is accessible by a plurality of users.

14. The apparatus of claim 11, wherein the request for access to the event indicates a request to access a venue at a time and location associated with a presentation of content.

15. The apparatus of claim 1, wherein the request for access indicates a user associated with the customer account, and wherein the processor is configured to execute instructions stored on the non-transitory medium to identify access to the event by the user.

16. The apparatus of claim 15, wherein the processor is configured to execute instructions stored on the non-transitory medium to reduce the cardinality of the available licensing units by the cardinality of the assigned units in response to identifying access to the event by the user.

17. The apparatus of claim 16, wherein access to the event by the user is identified in response to initiation of the event.

18. The apparatus of claim 12, wherein the request for access includes a request to register for the event.

19. The apparatus of claim 18, wherein the processor is configured to execute instructions stored on the non-transitory medium to, on a condition that the cardinality of the assigned units exceeds the cardinality of the available licensing units, store information indicating a registration for access to the event for the customer account.

20. A method comprising:
transmitting, by a processor in response to instructions stored on a non-transitory computer readable medium, a request for access to an event, the request for access indicating a customer account;
receiving a response indicating that the request is granted on a condition that a cardinality of assigned units for the event is within a cardinality of available licensing units allocated to the customer account; and
receiving a response indicating that the request is denied on a condition that the cardinality of the assigned units for the event exceeds the cardinality of the available licensing units.
